(19) United States
(12) Patent Application Publication
(10) Pub. No.: US 2020/0380533 A1
(43) Pub. Date: Dec. 3, 2020

(54) DRIVER VERIFICATION FOR RIDE HAILING SERVICE

(71) Applicant: Carrier Corporation, Palm Beach Gardens, FL (US)

(72) Inventor: Michael T. Lines, South Windsor, CT (US)

(21) Appl. No.: 16/886,952

(22) Filed: May 29, 2020

Related U.S. Application Data
(60) Provisional application No. 62/854,580, filed on May 30, 2019.

(51) Int. Cl. G06Q 30/00; G06Q 50/30; G06Q 50/26; H04W 12/06; H04W 4/02; G01C 21/34

(52) U.S. Cl. CPC G06Q 30/0185; G06Q 50/30; G06Q 50/265; G01C 21/3461; H04W 4/02; G01C 21/3492; H04W 12/06

(57) ABSTRACT

An example driver verification method includes transmitting a ride request from a first mobile device of a user to a server of a ride hailing service, and receiving a first credential at the first mobile device from the server. The first credential is associated with a driver and vehicle assigned to the ride request. The first mobile device receives a second credential from a second mobile device that is associated with the driver. A determination is made of whether the first credential corresponds to the second credential, and a driver verification notification is provided to the user in response thereto.

### CROSS-REFERENCE TO RELATED APPLICATIONS

This application claims the benefit of U.S. Provisional Application No. 62/854,580, filed on May 30, 2019, which is incorporated by reference herein in its entirety.

### BACKGROUND

This application relates to driver verification, more particularly to driver verification for a ride hailing service.

Ride hailing services, such as UBER® and LYFT®, have become a popular alternative to traditional taxis. Instead of relying on a phone call to a central taxi dispatcher, these ride hailing services allow users to use their smartphones to operate a downloadable application that shares their location and requests a ride from nearby drivers. The application typically provides a user with the name and photograph of their assigned driver, as well as a license plate number and description of the driver's vehicle. However, this has not prevented some passengers from entering the wrong vehicle when the users believed they were entering the vehicle of their assigned driver.

### SUMMARY

A driver verification method according to an example of the present disclosure includes transmitting a ride request from a first mobile device of a user to a server of a ride hailing service, and receiving a first credential at the first mobile device from the server, the first credential associated with a driver and vehicle assigned to the ride request. The method also includes receiving a second credential at the mobile device from a second mobile device that is associated with the assigned driver, determining whether the first credential corresponds to the second credential, and providing a driver verification notification to the user in response thereto.

In a further embodiment of any of the foregoing embodiments, the first credential and second credential are both single use authentication codes.

In a further embodiment of any of the foregoing embodiments, receiving the first credential is performed using a first type of wireless signaling, and receiving the second credential is performed using a second type of wireless signaling that is different from the first type of wireless signaling.

In a further embodiment of any of the foregoing embodiments, the second type of wireless signaling includes WiFi, Bluetooth, Bluetooth Low Energy, Zigbee, Near Field Communication, or infrared.

In a further embodiment of any of the foregoing embodiments, the method includes determining that the user has entered a vehicle that is different from the assigned vehicle before the ride request has been fulfilled by the assigned driver, and transmitting a security alert in response thereto.

In a further embodiment of any of the foregoing embodiments, determining that the user has entered a vehicle that is different from the assigned vehicle includes tracking a location of the user and the assigned driver, and determining that the user is moving at a speed indicative of vehicle usage at a location that is greater than a predefined distance away from the assigned driver.

In a further embodiment of any of the foregoing embodiments, the method includes determining that the user has entered a vehicle following a route that is inconsistent with the ride request, and transmitting a security alert in response thereto.

In a further embodiment of any of the foregoing embodiments, the method includes receiving a notification from the second mobile device indicating that multiple mobile devices are detected within the assigned vehicle, and providing an alert in response thereto.

In a further embodiment of any of the foregoing embodiments, the method includes providing a series of progressive alerts from the first mobile device to the user based on signaling from the server indicating how far the assigned vehicle is from the user.

A mobile device according to an example of the present disclosure includes one or more transceivers operable to communicate wirelessly with a server of a ride hailing service and with mobile devices associated drivers of the ride hailing service, and a processor operatively connected to the one or more transceivers. The processor is configured to transmit a ride request to the server and receive a first credential from the server, the first credential associated with a driver and vehicle assigned to the ride request. The processor is configured to receive a second credential from a second mobile device associated with the assigned driver. The processor is configured to determine whether the first credential corresponds to the second credential, and provide a driver verification notification to the user in response thereto.

In a further embodiment of any of the foregoing embodiments, the first credential and second credential are both single use authentication codes.

In a further embodiment of any of the foregoing embodiments, the processor is configured to utilize a first type of wireless signaling to receive the first credential, and utilize a second type of wireless signaling to receive the second credential.

In a further embodiment of any of the foregoing embodiments, the second type of wireless signaling comprises WiFi, Bluetooth, Bluetooth Low Energy, Zigbee, Near Field Communication, or infrared.

In a further embodiment of any of the foregoing embodiments, the processor is configured to determine that the user has entered a vehicle that is different from the assigned vehicle before the ride request has been fulfilled by the assigned driver, and transmit a security alert in response thereto.

In a further embodiment of any of the foregoing embodiments, to determine that the user has entered a vehicle that is different from the assigned vehicle, the processor is configured to track a location of the user and the assigned driver, and determine that the user is moving at a speed indicative of vehicle usage at a location that is greater than a predefined distance away from the assigned driver.

In a further embodiment of any of the foregoing embodiments, the processor is configured to determine that the user has entered a vehicle following a route that is inconsistent with the ride request, and transmit a security alert in response thereto.

In a further embodiment of any of the foregoing embodiments, the processor is configured to receive a notification from the second mobile device indicating that multiple mobile devices are detected within the assigned vehicle, and provide an alert in response thereto.

In a further embodiment of any of the foregoing embodiments, the processor is configured to provide a series of progressive alerts from the first mobile device to the user based on signaling from the server indicating how far the assigned vehicle is from the user.

A method of facilitating driver verification according to an example of the present disclosure includes receiving, using a first type of wireless signaling, an indication at a first mobile device of a driver. The indication is received from a server of a ride hailing service and indicates that the driver is assigned to a ride request transmitted from a second mobile device of a potential passenger. The method also includes transmitting, using a second type of wireless signaling, a credential from the first mobile device or another mobile device associated with the vehicle to the second mobile device of the potential passenger, thereby enabling the potential passenger to authenticate the driver in connection with the ride request.

In a further embodiment of any of the foregoing embodiments, the transmitting of the credential to the second mobile device is performed by said another mobile device associated with the vehicle, said another mobile device is a Bluetooth beacon, and the method includes detecting that multiple wireless terminals are located in the vehicle, and transmitting a notification to the second mobile device of the potential passenger in response to the detecting.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 is a schematic view of a ride hailing system.

FIG. 2 is a schematic view of a mobile device of the ride hailing system.

FIG. 3 illustrates a driver verification method for the ride hailing system.

### DETAILED DESCRIPTION

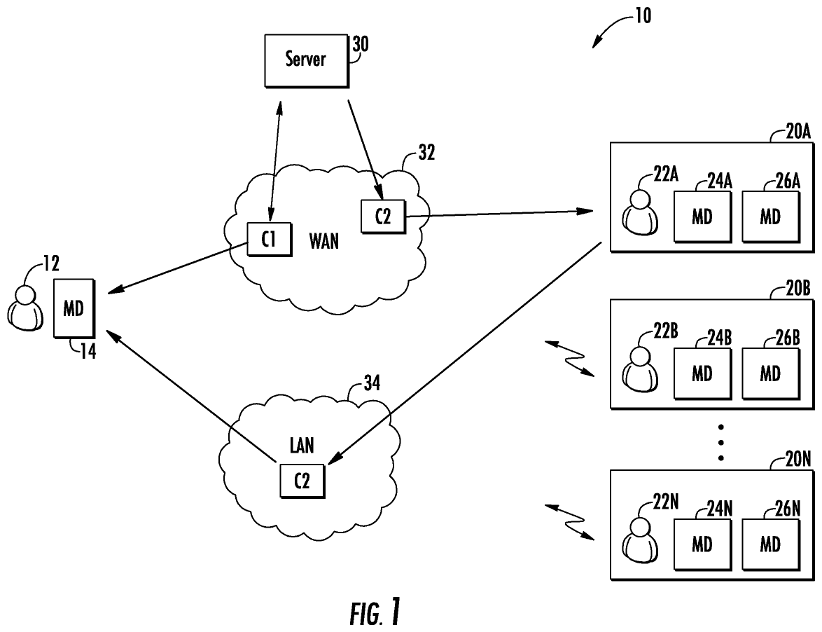

FIG. 1 is a schematic view of a ride hailing system 10 which allows a user 12, who is a potential passenger, to utilize their mobile device 14 to hail a ride from one of a plurality of drivers 22A-N that utilize their respective vehicles 20A-N to participate in a ride hailing service.

In the example of FIG. 1, each driver has a mobile device 24 configured to utilize a first type of signaling in wide area network (WAN) 32, and each driver 22 is also associated with an additional mobile device 26 configured to utilize a second type of signaling in a local area network (LAN) 34.

As used herein, a “mobile device” refers to an electronic device that is mobile and that includes wireless communication capabilities, such as a smartphone, tablet, or laptop. In one example, the mobile device 24 is a smartphone that has a graphical user interface, and the mobile device 26 is a beacon device (e.g., a Bluetooth beacon) that lacks a graphical user interface. In one example, the mobile devices 26 are omitted, and the mobile devices 24 are operable to utilize both the first and second type of signaling.

In one example, the first type of signaling is conducted using a predefined protocol standard such as one or more of the 802.11 standards or one or more cellular standards (e.g., GSM, CDMA, LTE, WiMax, etc.), and the second type of signaling utilizes direct device-to-device communication without using a network infrastructure (e.g., Bluetooth, Bluetooth Low Energy, Zigbee, Near Field Communication, infrared, etc.). Of course, it is understood that these are non-limiting examples, and other types of first and second signaling could be used.

The user 12 utilizes their mobile device 14 to submit a ride request to server 30 through the WAN 32 using the first type of signaling. The server 30 communicates with the drivers 22 of the vehicles 20 via the driver's mobile devices 24, and assigns the ride request to one of the drivers 22. Thus, a driver 22 and the driver's vehicle 20 are both assigned to the ride request. It is also noted that a driver 22 could associate a plurality of vehicles with a driver profile on the server 30. In this case, the driver can select which vehicle 20 will be used to pick up the user 12 from the plurality of vehicle choices. The decision of which vehicle can be based on another parameter (e.g., time of day, manual selection, day of week, and the like), and/or a default selection pre-selected by the driver 22.

Once a driver 22 is assigned to the ride request, the server 30 transmits a first credential C1 to the mobile device 14 of the user 12, and transmits a second credential C2 to the mobile device 24 and/or 26 of the assigned driver 22. FIG. 1 depicts driver 22A as being the assigned driver and vehicle 20A as being the assigned vehicle.

When the user 12 is within range of the assigned vehicle 22, the user's mobile device 14 receives the second credential C2 from the mobile device 24 and/or 26 associated with the assigned driver through the LAN 34. The mobile device 14 then determines whether the credentials C1 and C2 correspond to each other, and provides a driver verification notification in response thereto.

The credentials “corresponding” to each other could include the credentials matching, or being complementary in some other way (e.g., one being derivable from the other through a predefined operation such as hashing, for example).

If the credentials C1 and C2 correspond to each other, the mobile device 14 notifies the user 12 that the driver 22 providing the credential C2 is the assigned driver. Conversely, if the credentials C1 and C2 do not correspond to each other, the mobile device 14 notifies the user 12 that the driver 22 providing the credential C2 is not the assigned driver. This enables the user 12 to determine with a high degree of certainty that the vehicle they are about to enter is the assigned vehicle, and not a vehicle of a rogue driver, who may be a potential attacker. This determination can be performed by the mobile device 14 of the user 12 outside of and prior to entering a vehicle 20. In an example, additional credentialing could be done at an entry point of a vehicle 20. For example, the mobile device 24 or 26 could display a credential or analog thereof for observation by the user 12 or their mobile device 14 from outside the vehicle 20. For example, an image, text, QR code, bar code, or similar display could be initiated by the driver mobile device 24 or 26 which could be read by the user 12 or scanned by the user's mobile device 14 for verification of credentials.

In one example, a passenger verification feature is also provided to the driver 22, whereby the mobile device 24 receives the credential C1 from mobile device 14 through the LAN 34 and is able to determine that the user 12 they are about to pick up is their assigned passenger. This could increase driver safety by avoiding pickup of unintended passengers, who may be potential attackers.

In one example, the credentials C1 and C2 are both limited use authentication codes (e.g., single use codes), which reduces the likelihood that the credentials C1 and C2 can be stolen and misused.

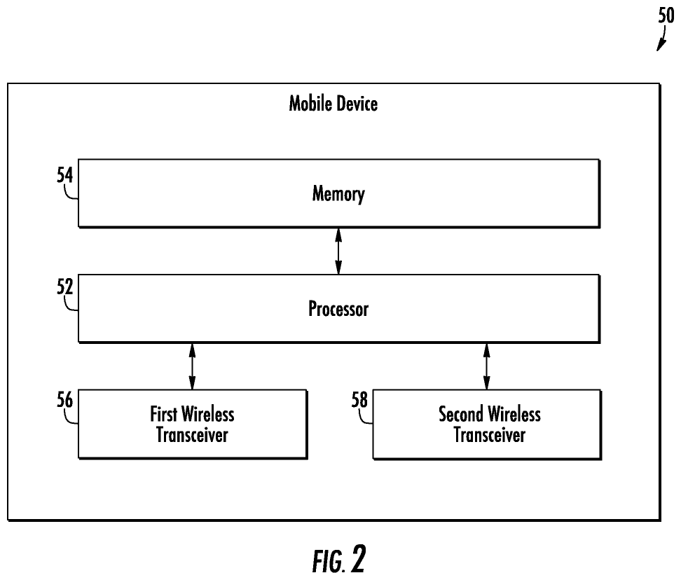

FIG. 2 is a schematic view of a mobile device 50 that can be used in the ride hailing system 10 of FIG. 1 as any of the mobile devices 14, 24, or 26. The mobile device 50 includes a processor 52 operatively connected to memory 54, a first wireless transceiver 56, and a second wireless transceiver 58. The processor 52 includes one or more processing circuits, such as microprocessors, microcontrollers, application specific integrated circuits (ASICs), or the like. The memory 54 may include one or several types of memory such as read-only memory (ROM), random-access memory, cache memory, flash memory devices, optical storage devices, etc. The memory 54 is configured to store one or more of the credentials C1 and C2 described above.

The first wireless transceiver 56 is configured to use the first type of signaling to communicate in the WAN 32, and the second wireless transceiver 58 is configured to use the second type of signaling in the LAN 34.

One of the transceivers 56, 58 can be omitted in an example such as the one depicted in FIG. 1, where a driver 22 uses mobile device 24 to communicate in the WAN 32 and uses a separate mobile device 26 (e.g., a beacon) to communicate in the LAN 34. In such an example, multiple transceivers may not be needed in a single driver/vehicle mobile device, because mobile device 24 includes a transceiver operable to use the first type of signaling, and mobile device 26 includes a transceiver operable to perform the second type of signaling.

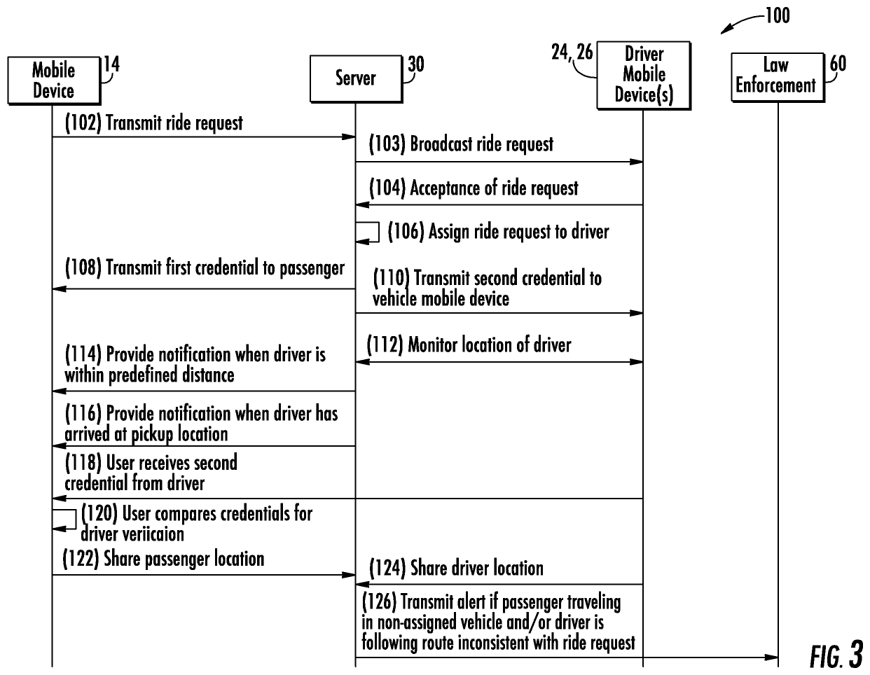

FIG. 3 illustrates an example driver verification method 100 for the ride hailing system 10. A user 12 utilizes their mobile device 14 to transmit a ride request to server 30 (step 102). In one example, the request is transmitted from a client application downloaded to the mobile device 14, and the request shares the user's location and their target destination. The request can optionally include a designation that the user 12 will only accept rides from drivers that offer “trusted driver verification” per the driver verification process described herein. This could incentivize drivers to participate in such a program, and potentially earn additional revenue by imposing a surcharge for verification service.

The server 30 broadcasts the ride request to the mobile devices 24 and/or 26 of a plurality of drivers 22 (step 103), and a particular one of the drivers 22 accepts the ride request by transmitting an acceptance from their mobile device 24 (step 104). In response, the server 30 assigns the ride request to the particular one of the drivers 22 (step 106), and transmits a first credential C1 to the mobile device 14 of user 12 through the WAN 32 using a first type of signaling (step 108), and transmits a second credential C2 that corresponds to the first credential C1 to the mobile device 24 or 26 of the driver 22 through the WAN 32 using a second type of signaling (step 110). Each of the credentials C1 and C2 correspond to each other and to the ride request. In one example, the first and second types of signaling are both cellular-based signaling, and are therefore the same type of signaling.

The server 30 monitors the location of the driver 22, such as by monitoring the location of one or both of the mobile devices 24, 26 (step 112), compares the driver 22 location with the user 12 location, and provides a notification to the user 12 when the driver 22 is within a predefined distance of the user 12 (step 114). The server 30 also provides a notification to the user 12 when the driver 22 has arrived at the pickup location specified in the ride request (step 116). Based on the notifications of steps 114 and 116, the mobile device 14 provides corresponding alerts to the user 12, such as vibrations of the phone, auditory sounds from the phone, display changes on the phone, etc.

In one example, in response to updates from the server 30 about the location of the driver 22 and/or vehicle 20, the mobile device 14 provides a series of progressive alerts to the user 12 of increasing intensity to indicate that the driver 22 is getting closer. This could include a first alert when the driver 22 is a first distance away, a second alert when the driver 22 is a second, closer distance away, a third alert when the driver 22 is a third, even closer distance away, etc. In one example, the alerts include different vibration patterns, intensities, or durations (e.g., first vibration pattern for first alert, second vibration pattern for second alert, and third vibration pattern for third alert) and/or include different auditory signals (e.g., first vibration only for first alert, second vibration plus sound for second alert, third vibration plus sound plus flashing screen for third alert).

Once the driver has arrived at the pickup location, the user 12 receives the second credential C2 from the mobile device 24 or 26 of the driver 22 through the LAN 34 using a third type of wireless signaling which may be different from the first and second types of signaling used in steps 108 and 110, respectively (step 118). The sharing of the second credential C2 from the driver's mobile device 24 or 26 to the user's mobile device 14 enables the user 12 to authenticate the driver 22 in connection with the ride request of step 102.

The mobile device 14 compares the credentials C1 and C2 to each other and provides a corresponding driver verification notification to the user 12 in response thereto (step 120), as discussed above. This driver verification notification allows the user 12 to know that they are entering the vehicle 20 of their assigned driver 22, and not the vehicle of a stranger not associated with the ride hailing system 10.

As discussed above, a passenger verification feature can also be provided to the driver 22, whereby the mobile device 24 receives the credential C1 from the mobile device 14 through the LAN 34 and is able to determine that the user 12 they are about to pick up is their assigned passenger.

In some examples, the ride hailing system 10 provides additional security features, such as detecting if the user 12 has entered a non-assigned vehicle, determining if the user is in a vehicle following a route inconsistent with the ride request, and/or warning the user 12 if there are multiple people in the vehicle of their assigned driver 22 (e.g., the driver, and someone hiding in the back of the vehicle).

To detect if the user 12 has entered a non-assigned vehicle that is different from the vehicle 20 of their assigned driver 22, the server 30 receives the user 12 location (step 122) and receives the driver 22 location (step 124). The server 30 analyzes changes in the user's location to determine if the user 12 is in a vehicle (e.g., if the user is traveling faster than a typical human walking and/or running speed, moving and physically located within a roadway per GPS coordinates, and the like). If the user 12 is determined to be in a vehicle but the ride request has not yet been fulfilled by the assigned driver 22 (e.g., the driver 22 has not yet picked up the user 12 and/or the user 12 is at a location that is greater than a predefined distance away from the driver 22), the server 30 transmits an alert to law enforcement 60.

The server can further transmit an alert to other users who have been preselected by the user 12 as emergency contacts. The alert can be transmitted to other users in text, cellular, or email format and can be configured to provide an audible or tactile event when received by the other user's mobile device. It should also be noted that a non-mobile computer device (such as a desktop computer) can be configured to receive alerts transmitted by the server 30.

To determine that the user 12 is following a route inconsistent with the ride request, the server 30 compares an actual route the user 12 is traveling and compares the route to the ride request. The route being “inconsistent” with the ride request could include the user 12 moving in an opposite direction than that of their target destination and/or the user 12 having been transported driven past the target destination. Another indicator the route is “inconsistent” can be an increase in an estimated duration of trip parameter (e.g., as determined by GPS software) above a threshold value. Further, a threshold of an estimated duration of trip parameter can be determined as a percentage of an original duration of the trip (e.g., calculate based on the user pickup location and their destination). In response to this detected inconsistency, a security alert is transmitted to law enforcement 126 and/or to the preselected emergency contacts of the user 12. This route consistency verification could be provided if the user 12 is in the assigned vehicle 20 or in a non-assigned vehicle.

In one example, the mobile device 26 is a Bluetooth beacon device operable to detect a number of mobile devices in the vehicle 20. As used herein, a “Bluetooth beacon” can use traditional Bluetooth and/or Bluetooth Low Energy.

If multiple mobile devices are determined to be in the vehicle 20, the server 30 provides a notification to the user's mobile device 14, which provides an alert in response to the user 12. In one example, the notification is only provided if the server 30 indicates that no passengers are currently supposed to be in the vehicle 20, as this could indicate that a potential attacker was present in the vehicle. Further, the user 12 can selectively disable notifications for known mobile devices (e.g., the mobile device of one's spouse, child, friend, and the like) to prevent potentially distracting nuisance notifications.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A driver verification method, comprising:
transmitting a ride request from a first mobile device of a user to a server of a ride hailing service;
receiving a first credential at the first mobile device from the server, the first credential associated with a driver and vehicle assigned to the ride request;
receiving a second credential at the mobile device from a second mobile device that is associated with the assigned driver; and
determining whether the first credential corresponds to the second credential, and providing a driver verification notification to the user in response thereto.

2. The method of claim 1, wherein the first credential and second credential are both single use authentication codes.

3. The method of claim 1, wherein:
said receiving the first credential is performed using a first type of wireless signaling; and
said receiving the second credential is performed using a second type of wireless signaling that is different from the first type of wireless signaling.

4. The method of claim 3, wherein the second type of wireless signaling comprises WiFi, Bluetooth, Bluetooth Low Energy, Zigbee, Near Field Communication, or infrared.

5. The method of claim 1, comprising:
determining that the user has entered a vehicle that is different from the assigned vehicle before the ride request has been fulfilled by the assigned driver; and
transmitting a security alert in response thereto.

6. The method of claim 5, wherein said determining that the user has entered a vehicle that is different from the assigned vehicle comprises:
tracking a location of the user and the assigned driver; and
determining that the user is moving at a speed indicative of vehicle usage at a location that is greater than a predefined distance away from the assigned driver.

7. The method of claim 1, comprising:
determining that the user has entered a vehicle following a route that is inconsistent with the ride request; and
transmitting a security alert in response thereto.

8. The method of claim 1, comprising:
receiving a notification from the second mobile device indicating that multiple mobile devices are detected within the assigned vehicle; and
providing an alert in response thereto.

9. The method of claim 1, comprising:
providing a series of progressive alerts from the first mobile device to the user based on signaling from the server indicating how far the assigned vehicle is from the user.

10. A mobile device, comprising:
one or more transceivers operable to communicate wirelessly with a server of a ride hailing service and with mobile devices associated drivers of the ride hailing service; and
a processor operatively connected to the one or more transceivers and configured to:
transmit a ride request to the server;
receive a first credential from the server, the first credential associated with a driver and vehicle assigned to the ride request;
receive a second credential from a second mobile device that is associated with the assigned driver; and
determine whether the first credential corresponds to the second credential, and provide a driver verification notification to the user in response thereto.

11. The mobile device of claim 10, wherein the first credential and second credential are both single use authentication codes.

12. The mobile device of claim 10, wherein the processor is configured to utilize a first type of wireless signaling to receive the first credential, and utilize a second type of wireless signaling to receive the second credential.

13. The mobile device of claim 12, wherein the second type of wireless signaling comprises WiFi, Bluetooth, Bluetooth Low Energy, Zigbee, Near Field Communication, or infrared.

14. The mobile device of claim 10, wherein the processor is configured to:
determine that the user has entered a vehicle that is different from the assigned vehicle before the ride request has been fulfilled by the assigned driver; and
transmit a security alert in response thereto.

15. The mobile device of claim 14, wherein to determine that the user has entered a vehicle that is different from the assigned vehicle, the processor is configured to:
track a location of the user and the assigned driver; and
determine that the user is moving at a speed indicative of vehicle usage at a location that is greater than a predefined distance away from the assigned driver.

16. The mobile device of claim 10, wherein the processor is configured to:
determine that the user has entered a vehicle following a route that is inconsistent with the ride request; and
transmit a security alert in response thereto.

17. The mobile device of claim 10, wherein the processor is configured to:
receive a notification from the second mobile device indicating that multiple mobile devices are detected within the assigned vehicle; and
provide an alert in response thereto.

18. The mobile device of claim 10, wherein the processor is configured to:
provide a series of progressive alerts from the first mobile device to the user based on signaling from the server indicating how far the assigned vehicle is from the user.

19. A method of facilitating driver verification, comprising:
receiving, using a first type of wireless signaling, an indication at a first mobile device of a driver, the indication received from a server of a ride hailing service and indicating that the driver is assigned to a ride request transmitted from a second mobile device of a potential passenger; and
transmitting, using a second type of wireless signaling, a credential from the first mobile device or another mobile device associated with the vehicle to the second mobile device of the potential passenger, thereby enabling the potential passenger to authenticate the driver in connection with the ride request.

20. The method of claim 19:
wherein said transmitting is performed by said another mobile device associated with the vehicle, and said another mobile device is a Bluetooth beacon;
the method comprising:
detecting that multiple wireless terminals are located in the vehicle; and
transmitting a notification to the second mobile device of the potential passenger in response to the detecting.
